(19) United States
(12) Patent Application Publication
(10) Pub. No.: US 2024/0331078 A1
(43) Pub. Date: Oct. 3, 2024

(54) METHOD, INFORMATION PROCESSING DEVICE, AND STORAGE MEDIUM

(71) Applicants: TOYOTA JIDOSHA KABUSHIKI KAISHA, Toyota-shi (JP); DENSO TEN Limited, Kobe-shi (JP)

(72) Inventors: Ryogo NONAKA, Kawasaki-shi (JP); Ai Miyata, Hirakata-shi (JP); Keisuke Okamoto, Chofu-shi (JP); Yuka Takiguchi, Fukaya-shi (JP); Nahoko Shibano, Tokyo (JP); Yuta Shishime, Tokyo (JP); Tsuyoshi Okada, Nagoya-shi (JP); Shota Komatsu, Kobe-shi (JP)

(73) Assignees: TOYOTA JIDOSHA KABUSHIKI KAISHA, Toyota-shi (JP); DENSO TEN Limited, Kobe-shi (JP)

(21) Appl. No.: 18/617,056

(22) Filed: Mar. 26, 2024

(30) Foreign Application Priority Data
Mar. 29, 2023 (JP) 2023-054216

(51) Int. Cl. G06Q 50/47

(52) U.S. Cl. CPC G06Q 50/47

(57) ABSTRACT

A method that is performed by an information processing device includes: acquiring attribute information of each of a plurality of spectators who is going to visit an event venue; dividing the spectators into two or more groups based on the attribute information; and determining an operation plan for two or more vehicles so as to transport the spectators in the same group to the event venue by the same vehicle.

### CROSS-REFERENCE TO RELATED APPLICATION

This application claims priority to Japanese Patent Application No. 2023-054216 filed on Mar. 29, 2023, incorporated herein by reference in its entirety.

### BACKGROUND

### 1. Technical Field

The present disclosure relates to methods, information processing devices, and storage media.

### 2. Description of Related Art

Conventionally, the technology for transporting users who are going to visit an event venue are known in the art. For example, Japanese Unexamined Patent Application Publication No. 2022-080651 (JP 2022-080651 A) discloses acquiring event information for each user and relationships between users, creating groups based on the acquired information, and proposing a shared trip with the group.

### SUMMARY

There is room for improvement in technology for transporting users who are going to visit an event venue.

An object of the present disclosure made in view of such circumstances is to improve the technology for transporting users who are going to visit an event venue.

An aspect of the present disclosure provides a method that is performed by an information processing device. The method includes: acquiring attribute information of each of a plurality of spectators who is going to visit an event venue; dividing the spectators into two or more groups based on the attribute information; and determining an operation plan for two or more vehicles so as to transport the spectators in the same group to the event venue by the same vehicle.

An aspect of the present disclosure provides a storage medium storing instructions that are executable by one or more processors and that cause the one or more processors to perform functions. The functions include: acquiring attribute information of each of a plurality of spectators who is going to visit an event venue; dividing the spectators into two or more groups based on the attribute information; and determining an operation plan for two or more vehicles so as to transport the spectators in the same group to the event venue by the same vehicle.

An aspect of the present disclosure provides an information processing device including a control unit. The control unit is configured to: acquire attribute information of each of a plurality of spectators who is going to visit an event venue; divide the spectators into two or more groups based on the attribute information; and determine an operation plan for two or more vehicles so as to transport the spectators in the same group to the event venue by the same vehicle.

According to the present disclosure, the technology for transporting users who are going to visit an event venue is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a block diagram showing a schematic configuration of a terminal device;

FIG. 3 is a block diagram showing a schematic configuration of an information processing device;

FIG. 4 is a block diagram showing a schematic configuration of a vehicle; and

FIG. 5 is a flowchart showing operation of the information processing device.

### DETAILED DESCRIPTION OF EMBODIMENTS

An embodiment of the present disclosure will be described below.

### Overview of Embodiment

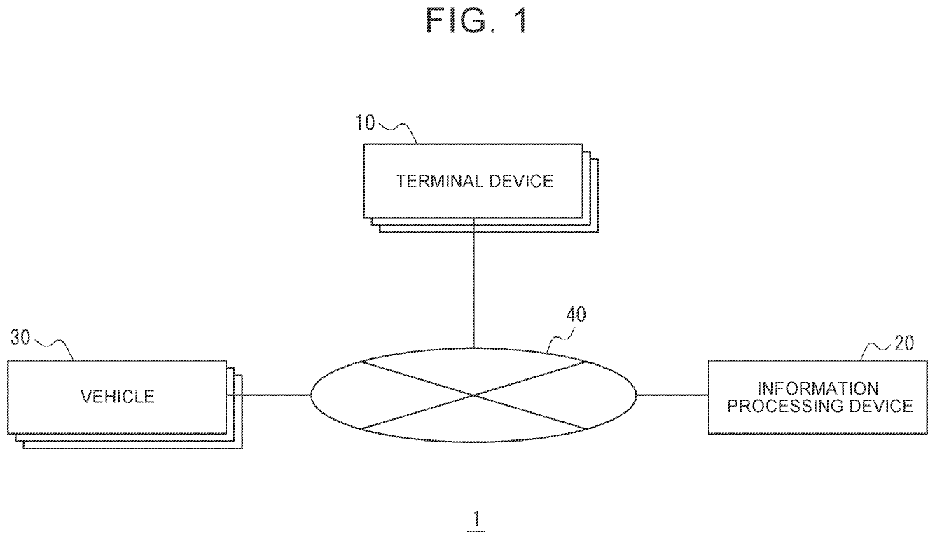

The overview of a system 1 according to an embodiment of the present disclosure will be given with reference to FIG. 1. The system 1 includes a plurality of terminal devices 10, an information processing device 20, and a plurality of vehicles 30. The terminal devices 10, the information processing device 20, and the vehicles 30 are connected to a network 40 including, for example, the Internet, a mobile communication network, etc. so that they can communicate with each other. In the present embodiment, the system 1 is used to determine an operation plan for the vehicles 30 so as to transport a plurality of spectators who is going to visit an event venue. The event venue may be, but is not limited to, an arena, a stadium, or a festival venue.

The terminal devices 10 are any computers that are used by users. Examples of the terminal devices 10 include general-purpose computers such as smartphones or tablets, and dedicated computers. For example, a user can use the terminal device 10 to purchase a ticket for an event that is held at an event venue. In the present embodiment, it is assumed that the event that is held at the event venue is a sports game. However, the event is not limited to this example and may be any event. In the following description, it is assumed that the users of the terminal devices 10 are spectators who are planning on visiting the event venue.

The information processing device 20 is, for example, a server device. However, the information processing device 20 is not limited to this, and may be any computer. The information processing device 20 is configured to communicate with the terminal devices 10 via the network 40. In the present embodiment, the information processing device 20 determines an operation plan for the vehicles 30.

The vehicles 30 are, for example, motor vehicles. However, the vehicles 30 are not limited to these, and may be any vehicles. The motor vehicles may be, but are not limited to, battery electric vehicles (BEVs), hybrid electric vehicles (HEVs), plug-in hybrid electric vehicles (PHEVs), or fuel cell electric vehicles (FCEVs). The vehicles 30 may be configured to be driven directly or remotely by a driver. Alternatively, the vehicles 30 may be configured to be driven at Levels 1 to 5 of driving automation defined by the Society of Automotive Engineers (SAE). The system 1 may include any number of vehicles 30 equal to or greater than two. In the present embodiment, the vehicles 30 transport spectators to the event venue according to the operation plan made by the information processing device 20.

The overview of the present embodiment will be given first, and details of the present embodiment will be given later. The information processing device 20 acquires attribute information of each of a plurality of spectators who is going to visit an event venue. The information processing device 20 divides the spectators into two or more groups based on the attribute information. The information processing device 20 then determines an operation plan for the two or more vehicles 30 so as to transport the spectators in the same group to the event venue by the same vehicle 30.

As described above, according to the present embodiment, a plurality of spectators who is going to visit an event venue is divided into two or more groups based on their attribute information. The spectators are transported to the event venue by the vehicles 30 in groups according to the operation plan. Having the spectators put in the same group based on the attribute information ride in the same vehicle 30 can facilitate interaction among them during the ride in the vehicle 30. For example, when a sports game is held at the event venue, having spectators rooting for the same team ride in the same vehicle 30 can facilitate interaction among them even during the trip to the event venue. Accordingly, the technology for transporting users who are going to visit an event venue is improved in that interaction among spectators during the trip to the event venue can be facilitated.

### Configuration of Terminal Device

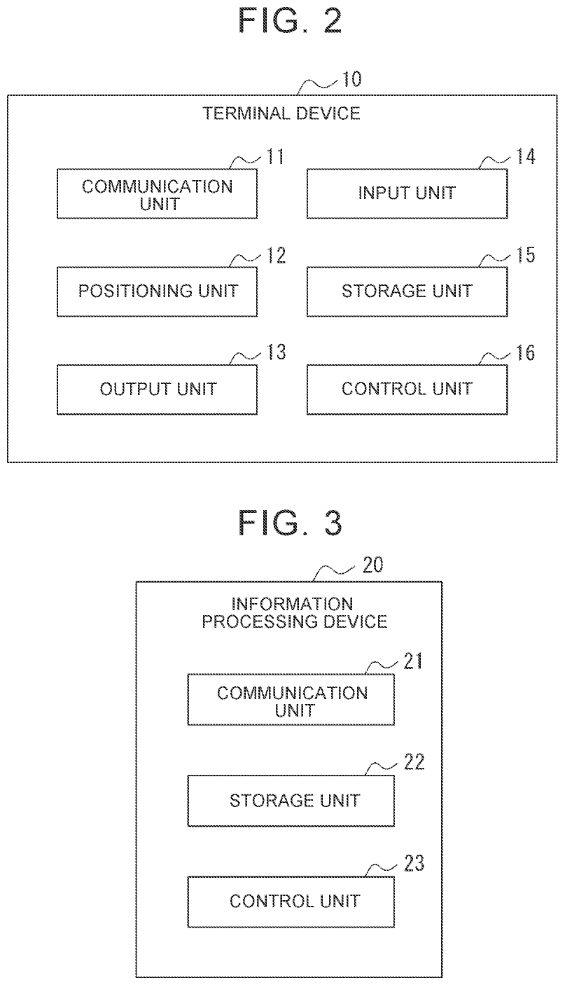

Next, the configurations of the system 1 will be described in detail. As shown in FIG. 2, the terminal device 10 includes a communication unit 11, a positioning unit 12, an output unit 13, an input unit 14, a storage unit 15, and a control unit 16.

The communication unit 11 includes one or more communication interfaces for connecting to the network 40. The communication interface supports, for example, a mobile communication standard such as fourth generation (4G) or fifth generation (5G), a wired local area network (LAN) standard, or a wireless LAN standard. However, the supported standard is not limited to these, and the communication interface may support any communication standard. In the present embodiment, the terminal device 10 communicates with the information processing device 20 via the communication unit 11 and the network 40.

The positioning unit 12 includes one or more devices that acquire location information of the terminal device 10. Specifically, the positioning unit 12 includes, for example, a receiver compatible with the Global Positioning System (GPS). However, the receiver is not limited to this, and the positioning unit 12 may include a receiver compatible with any satellite positioning system. When the terminal device 10 is a mobile terminal that can be carried by the user, the location information of the terminal device 10 may be treated as location information of the user.

The output unit 13 may include one or more output devices that output information to notify the user. The output device may be, but is not limited to, a display that outputs information as images or a speaker that outputs information as audio. The output unit 13 may include an interface for connecting an external output device.

The input unit 14 may include one or more input devices that detect user input. The input device may be, but is not limited to, a physical key, a capacitive key, a touch screen integrated with a display, a microphone that receives voice input, or a camera. The input unit 14 may include an interface for connecting an external input device.

The storage unit 15 includes one or more memories. The memory may be, but is not limited to, a semiconductor memory, a magnetic memory, or an optical memory.

Each memory included in the storage unit 15 may function as, for example, a main storage device, an auxiliary storage device, or a cache memory. The storage unit 15 stores any information to be used for operation of the terminal device 10. For example, the storage unit 15 may store a system program, an application program, and embedded software. The information stored in the storage unit 15 may be updatable with, for example, information acquired from the network 40 via the communication unit 11.

The control unit 16 includes one or more processors, one or more programmable circuits, one or more dedicated circuits, or a combination thereof. The processor may be, but is not limited to, a general-purpose processor such as a central processing unit (CPU) or a graphics processing unit (GPU), or a dedicated processor specialized for a specific process. The programmable circuit may be, but is not limited to, a field-programmable gate array (FPGA). The dedicated circuit may be, but is not limited to, an application specific integrated circuit (ASIC). The control unit 16 controls the overall operation of the terminal device 10.

### Configuration of Information Processing Device

As shown in FIG. 3, the information processing device 20 includes a communication unit 21, a storage unit 22, and a control unit 23.

The communication unit 21 includes one or more communication interfaces for connecting to the network 40. The communication interface supports, for example, a mobile communication standard, a wired LAN standard, or a wireless LAN standard. However, the supported standard is not limited to these, and the communication interface may support any communication standard. In the present embodiment, the information processing device 20 communicates with the terminal devices 10 via the communication unit 21 and the network 40.

The storage unit 22 includes one or more memories. Each memory included in the storage unit 22 may function as, for example, a main storage device, an auxiliary storage device, or a cache memory. The storage unit 22 stores any information to be used for operation of the information processing device 20. For example, the storage unit 22 may store a system program, an application program, a database, and map information. The information stored in the storage unit 22 may be updatable with, for example, information acquired from the network 40 via the communication unit 21.

The control unit 23 includes one or more processors, one or more programmable circuits, one or more dedicated circuits, or a combination thereof. The control unit 23 controls the overall operation of the information processing device 20. Configuration of Vehicle

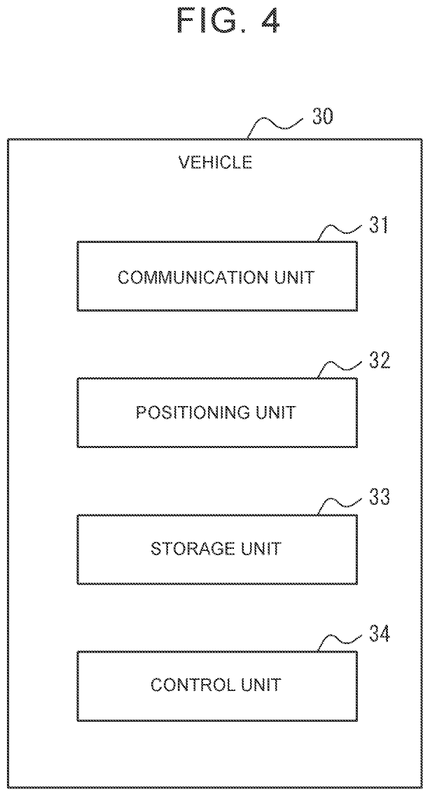

As shown in FIG. 4, the vehicle 30 includes a communication unit 31, a positioning unit 32, a storage unit 33, and a control unit 34.

The communication unit 31 includes one or more communication interfaces for connecting to the network 40. The communication interface supports, for example, a mobile communication standard, but the supported standard is not limited to this. In the present embodiment, the vehicle 30 communicates with the information processing device 20 via the communication unit 31 and the network 40.

The positioning unit 32 includes one or more devices that acquire location information of the vehicle 30. Specifically, the positioning unit 32 includes, for example, a receiver compatible with the GPS. However, the receiver is not limited to this, and the positioning unit 32 may include a receiver compatible with any satellite positioning system.

The storage unit 33 includes one or more memories. Each memory included in the storage unit 33 may function as, for example, a main storage device, an auxiliary storage device, or a cache memory. The storage unit 33 stores any information to be used for operation of the vehicle 30. For example, the storage unit 33 may store a system program, an application program, embedded software, and map information. The information stored in the storage unit 33 may be updatable with, for example, information acquired from the network 40 via the communication unit 31.

The control unit 34 includes one or more processors, one or more programmable circuits, one or more dedicated circuits, or a combination thereof. The control unit 34 controls the overall operations of the vehicle 30.

### Operation Flow of Information Processing Device

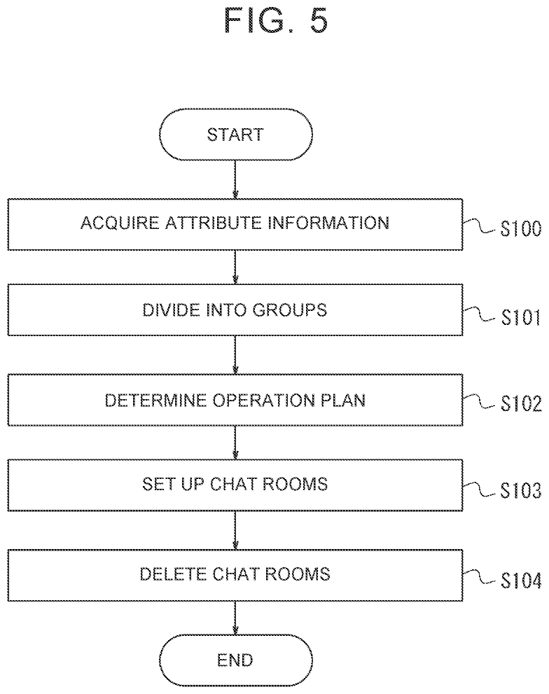

The operation of the information processing device 20 according to the present embodiment will be described with reference to FIG. 5.

Step S100: The control unit 23 of the information processing device 20 acquires attribute information of each of a plurality of spectators who is going to visit an event venue.

Specifically, the control unit 23 acquires attribute information of each spectator who is planning to visit the event venue for an event with a fixed date and time etc. The attribute information is acquired, for example, at the time of ticket purchase or several days before the event date. However, the timing to acquire the attribute information is not limited to these, and the attribute information may be acquired at any time. The acquired information may be updatable by the spectator.

Any method can be used to acquire the attribute information. For example, the control unit 23 of the information processing device 20 may acquire the attribute information entered to the terminal device 10 by a spectator at the time of ticket purchase by receiving it via the communication unit 21 and the network 40.

The attribute information may include any information regarding the spectator. In the present embodiment, the attribute information includes information indicating a participant or participating organization marked as interested by the spectator (e.g., an athlete or team the spectator is rooting for) out of a plurality of participants (e.g., participating athletes) or plurality of participating organizations (e.g., participating teams) of the event that is held at the event venue.

Step S101: The control unit 23 divides the spectators into two or more groups based on the attribute information.

Any method can be used to group the spectators. In the present embodiment, the control unit 23 puts those spectators whose interest indicated in the attribute information is the same (e.g., spectators rooting for the same team) in the same group.

Step S102: The control unit 23 determines an operation plan for the two or more vehicles 30 so as to transport the spectators in the same group to the event venue by the same vehicle 30.

Specifically, the control unit 23 allocates the vehicles 30 to each group formed in step S101, and determines an operation plan for the vehicles 30 so as to transport the two or more groups to the event venue by the two or more vehicles 30.

The operation plan may include any information regarding the operation of the vehicles 30. For example, the operation plan includes information associating the vehicles 30, the drivers of the vehicles 30, and the groups that are going to ride in the vehicles 30 with each other, and route information of the vehicles 30. The route information of the vehicle 30 includes, for example, information indicating departure point, destination, scheduled departure time, scheduled arrival time, waypoint(s), and travel route. However, the route information is not limited to these, and may include any information regarding the route of the vehicle 30.

Step S103: The control unit 23 sets up two or more chat rooms corresponding to the two or more groups.

Specifically, the control unit 23 creates a chat room for each group. The control unit 23 then adds a user account of each spectator belonging to the group to the chat room corresponding to the group. A chat room is a virtual space where spectators can interact with each other by sending and receiving messages including, for example, texts, images, or audio. The spectators associated with the user accounts added to the same chat room can interact with each other using, for example, the terminal devices 10.

The chat room is, for example, in a chat format or a timeline format. However, the format is not limited to these, and the chat room may be in any format. Moreover, the chat rooms may be set up any time after the groups are formed. According to this configuration, interaction among the spectators can be facilitated even in situations other than during the trip to the event venue.

Step S104: The control unit 23 deletes the two or more chat rooms after the event held at the event venue ends.

The chat rooms may be deleted at any time after the event ends.

As described above, the information processing device 20 acquires attribute information of each of a plurality of spectators who is going to visit an event venue. The information processing device 20 divides the spectators into two or more groups based on the attribute information. The information processing device 20 then determines an operation plan for the two or more vehicles 30 so as to transport the spectators in the same group to the event venue by the same vehicle 30.

According to the above configuration, a plurality of spectators who is going to visit an event venue is divided into two or more groups based on their attribute information. The spectators are transported to the event venue by the vehicles 30 in groups according to the operation plan. Having the spectators who are put in the same group based on the attribute information ride in the same vehicle 30 can facilitate interaction among them during the ride in the vehicle 30. For example, when a sports game is held at the event venue, having spectators rooting for the same team ride in the same vehicle 30 can facilitate interaction among them even during the trip to the event venue. Accordingly, the technology for transporting users who are going to visit an event venue is improved in that interaction among spectators during the trip to the event venue can be facilitated.

Although the present disclosure is described above based on the drawings and the embodiment, it should be noted that those skilled in the art may make various modifications and alterations thereto based on the present disclosure. It should therefore be understood that these modifications and alterations are within the scope of the present disclosure. For example, the functions included in the configurations, steps, etc. can be rearranged so as not to be logically inconsistent, and a plurality of configurations, steps, etc. can be combined into one or divided into sub-configurations, sub-steps, etc.

For example, in the above embodiment, the configuration and operation of the information processing device 20 may be distributed between or among a plurality of computers configured to communicate with each other. Embodiments are also possible in which part or all of the components of the information processing device 20 are provided in the terminal device 10.

In the above embodiment, the operation flow of the information processing device 20 is divided into steps S100 to S104. However, embodiments in which part of the steps is omitted are also possible. For example, the operations in steps S103 to S104 may be omitted.

The above embodiment illustrates an example in which attribute information includes information indicating a participant or participating organization marked as interested by the spectator out of a plurality of participants or plurality of participating organizations of the event that is held at the event venue. The above embodiment also illustrates an example in which, when dividing a plurality of spectators into two or more groups based on attribute information, the control unit 23 puts those spectators whose interest indicated in the attribute information is the same in the same group.

However, the content of the attribute information and the method for grouping based on the attribute information are not limited to these examples.

For example, the attribute information may include position information of the spectator's reserved seat at the event venue. The control unit 23 may put those spectators whose reserved seats are separated from each other by a predetermined distance or more (e.g., those spectators whose reserved seats' row numbers are different from each other by three or more) in the same group. It is generally difficult for spectators whose reserved seats are not next to each other to interact at an event venue. According to the above modification of the embodiment, however, those spectators whose reserved seats are separated from each other by the predetermined distance or more, that is, those spectators who cannot easily interact with each other at an event venue, are grouped together. This can increase the opportunities for them to interact with each other.

The above embodiment may be modified so that the attribute information is used to determine the operation plan.

For example, the control unit 23 may acquire, for each group, the scheduled time for the participant or participating organization the spectators of the group are interested in (e.g., the team they are rooting for) to arrive at the event venue. Any method can be used to acquire the scheduled time. The control unit 23 may then set the time earlier than the acquired scheduled time (e.g., 10 minutes before the scheduled time) as target time for each group. The control unit 23 may determine an operation plan so as to allow each group to arrive at the event venue by the target time set for the group. According to this configuration, for example, the spectators arrive at the event venue earlier than the scheduled time for the team they are rooting for to arrive at the event venue, so that they can see the athletes entering the event venue. This can improve the event experience for the spectators.

For example, the control unit 23 may acquire a facility related to the participant or participating organization the spectators of the group are interested in. Any method can be used to acquire the related facility. The control unit 23 may then set, for each group, the acquired related facility as a waypoint. Subsequently, the control unit 23 may determine an operation plan so as to allow each group to arrive at the event venue via the waypoint set for the group. Examples of the related facility include facilities in the Olympic Village that were used in the past by the participating athlete during the Olympic Games. Passing through the waypoint allows more active interaction among the spectators.

For example, an embodiment is also possible in which a general-purpose computer functions as the information processing device 20 according to the above embodiment. Specifically, a program describing processing for implementing each function of the information processing device 20 according to the above embodiment is stored in a memory of the general-purpose computer, and the program is read and executed by the processor. Therefore, the present disclosure can also be implemented as a program that can be executed by the processor or a non-transitory computer-readable medium that stores the program.

In the above embodiment, the vehicles 30 may be autonomous vehicles that do not need to be driven by a driver. In such a case, the control unit 23 of the information processing device 20 may control autonomous driving of each vehicle 30 sending to each vehicle 30 an instruction to operate according to the determined operation plan.

What is claimed is:

1. A method that is performed by an information processing device, the method comprising:
acquiring attribute information of each of a plurality of spectators who is going to visit an event venue;
dividing the spectators into two or more groups based on the attribute information; and
determining an operation plan for two or more vehicles so as to transport the spectators in the same group to the event venue by the same vehicle.

2. The method according to claim 1, further comprising setting up two or more chat rooms corresponding to the two or more groups.

3. The method according to claim 2, further comprising deleting the two or more chat rooms after an event held at the event venue ends.

4. The method according to claim 1, wherein:
the attribute information includes position information of a reserved seat for the spectator at the event venue; and
the information processing device puts those spectators whose reserved seats are separated from each other by a predetermined distance or more in the same group.

5. The method according to claim 1, wherein:
the attribute information includes information indicating a participant or participating organization marked as interested by the spectator out of a plurality of participants or plurality of participating organizations of an event that is held at the event venue; and
the information processing device puts those spectators interested in the same participant or participating organization in the same group.

6. The method according to claim 5, further comprising setting, for each group, time earlier than scheduled time for the participant or participating organization the spectators of the group are interested in to arrive at the event venue as target time, wherein the information processing device determines the operation plan so as to allow each group to arrive at the event venue by the target time set for the group.

7. The method according to claim 5, further comprising setting, for each group, a facility related to the participant or participating organization the spectators of the group are interested in as a waypoint, wherein
the information processing device determines the operation plan so as to allow each group to arrive at the event venue via the waypoint set for the group.

8. A non-transitory storage medium storing instructions that are executable by one or more processors and that cause the one or more processors to perform functions, wherein the functions comprising:
acquiring attribute information of each of a plurality of spectators who is going to visit an event venue;
dividing the spectators into two or more groups based on the attribute information; and
determining an operation plan for two or more vehicles so as to transport the spectators in the same group to the event venue by the same vehicle.

9. The non-transitory storage medium according to claim 8, wherein the functions further comprise setting up two or more chat rooms corresponding to the two or more groups.

10. The non-transitory storage medium according to claim 9, wherein the functions further comprise deleting the two or more chat rooms after an event held at the event venue ends.

11. The non-transitory storage medium according to claim 8, wherein:
the attribute information includes position information of a reserved seat for the spectator at the event venue; and
the processor is configured to put those spectators whose reserved seats are separated from each other by a predetermined distance or more in the same group.

12. The non-transitory storage medium according to claim 8, wherein:
the attribute information includes information indicating a participant or participating organization marked as interested by the spectator out of a plurality of participants or plurality of participating organizations of an event that is held at the event venue; and
the functions further comprise putting those spectators interested in the same participant or participating organization in the same group.

13. The non-transitory storage medium according to claim 12, wherein the functions further comprise:
setting, for each group, time earlier than scheduled time for the participant or participating organization the spectators of the group are interested in to arrive at the event venue as target time; and
determining the operation plan so as to allow each group to arrive at the event venue by the target time set for the group.

14. The non-transitory storage medium according to claim 12, wherein the functions further comprise:
setting, for each group, a facility related to the participant or participating organization the spectators of the group are interested in as a waypoint; and
determining the operation plan so as to allow each group to arrive at the event venue via the waypoint set for the group.

15. An information processing device, comprising a control unit, wherein the control unit is configured to
acquire attribute information of each of a plurality of spectators who is going to visit an event venue,
divide the spectators into two or more groups based on the attribute information, and
determine an operation plan for two or more vehicles so as to transport the spectators in the same group to the event venue by the same vehicle.

16. The information processing device according to claim 15, wherein the control unit is configured to set up two or more chat rooms corresponding to the two or more groups.

17. The information processing device according to claim 15, wherein:
the attribute information includes position information of a reserved seat for the spectator at the event venue; and
the control unit is configured to, when dividing the spectators into the two or more groups, put those spectators whose reserved seats are separated from each other by a predetermined distance or more in the same group.

18. The information processing device according to claim 15, wherein:
the attribute information includes information indicating a participant or participating organization marked as interested by the spectator out of a plurality of participants or plurality of participating organizations of an event that is held at the event venue; and
the control unit is configured to, when dividing the spectators into the two or more groups, put those spectators interested in the same participant or participating organization in the same group.

19. The information processing device according to claim 18, wherein the control unit is configured to
set, for each group, time earlier than scheduled time for the participant or participating organization the spectators of the group are interested in to arrive at the event venue as target time, and
determine the operation plan so as to allow each group to arrive at the event venue by the target time set for the group.

20. The information processing device according to claim 18, wherein the control unit is configured to
set, for each group, a facility related to the participant or participating organization the spectators of the group are interested in as a waypoint, and
determine the operation plan so as to allow each group to arrive at the event venue via the waypoint set for the group.
